(19) United States
(12) Patent Application Publication
(10) Pub. No.: US 2015/0244305 A1
(43) Pub. Date: Aug. 27, 2015

(54) BYOE_Bring Your OWN Enegi_Consumer Rechargeable Household Batteries_Pawabox-iPak

(71) Applicant: Francis Lugbenga Odubekun, Newark, NJ (US)

(72) Inventor: Francis Lugbenga Odubekun, Newark, NJ (US)

(21) Appl. No.: 14/190,111

(22) Filed: Feb. 26, 2014

(51) Int. Cl. H02S 10/20; H01M 10/42

(52) U.S. Cl. CPC H02S 10/20; H01M 10/42

(57) ABSTRACT

This model is somewhat similar to that of cooking gas; whereby consumers take empty cylinders to a nearby dealer to be refilled. That enables the consumer to be able to avoid the cost of maintaining huge stockpiles of gas themselves. It will also usher in the era of “distributed generation” of electricity; as opposed to the current model of “centralized generation”, whereby, electricity is generated hundreds, sometimes thousands of miles away and transmitted by high transmission wires to the end user, with several megawatts of electricity being “lost” in the process. Also, countries that have the centralized distribution model, are constantly faced with the spectre of “grid failure”, which “distributed generation” avoids.

Technology has enabled us to move to a “wireless” world in the field of telephony; with attendant benefit and increased productivity and unlocking of economic potential. This model is expected to yield similar results in the world of electricity.

It is envisioned that oil companies will take an increasing role in generating solar electricity, using the available capacity they have on the roofs of their extensive network of petrol stations. This will also enable oil companies to get in front of the trend towards renewable energy generation, which they've been increasingly talking about.

Oil companies moving to become “electricity providers” will also be similar to cable companies in the US, using available capacity on their cables to become telephone service and internet service providers; thereby increasing competition and bringing new technology, expertise and capital to those sectors. Likewise, it is expected that oil companies getting into the “distributed generation” of electricity model will yield far-reaching economies.

### MAIN FEATURES

Portable, battery packs (Lithium ion) that can be re-charged at Gasoline/Petrol filling stations; who will in turn obtain their electricity from various sources; e.g., from:

Solar panels

Wind generators

Micro hydro

Utility power

Diesel gensets

Voltage=approx. 25.2v

Capacity=approx. 58 Ah

Weight=approx. 10 kg

### VALUE PROPOSITION

Cheap/inexpensive/affordable

Portable

Light (<20 lbs/10 kg)

Well packaged, with carrying handles, etc.

Powerful (approx. 2 KW)

Powerful enough to power basic appliances:

TV (42 inch LCD)

Fridge (Energy Efficient Fridge)

Laptop (50 watts)

Lights (5×20 watt LED lights)

Fan (100 watts)

Well water pump (100 watts)

Safe (Not being powerful enough to power an air conditioner reduces its unsafeness)

Key Relationships:

Partner with gas/petrol companies and others, to install solar panels and electrical chargers at gas/petrol filling stations.

Models:

e.g., gas/gas cylinders which can be re-filled/swapped anywhere.

1. This is expected to usher in the era of “distributed generation” of electricity; whereby instead of the current “centralized distribution” model, whereby electricity is generated in huge amounts, then transmitted over hundreds or thousands of miles to the end user; in this model, electricity will be generated “locally” and “sold” to end users in batteries. This will usher in “distributed generation” of electricity.
It will avoid the loss of megawatts of electricity that is lost when electricity is transmitted over long distances.
Partnering with petrol filling stations to install solar panels on their roofs will take advantage of “unutilized space” that most, if not all, petrol filling stations currently have.
Right now the cost of batteries and solar panels together is too high for the average consumer; therefore, being able to “recharge” or “refill” batteries at a relatively nearby petrol filling station would make “distributed generation” of electricity more affordable than it otherwise would be.
